(19) United States
(12) Patent Application Publication
(10) Pub. No.: US 2018/0362001 A1
(43) Pub. Date: Dec. 20, 2018

(54) TRAVELING CONTROL APPARATUS

(71) Applicant: DENSO CORPORATION, Kariya-city, Aichi-pref. (JP)

(72) Inventors: Hiroshi INOU, Kariya-city, Aichi-pref. (JP); Teppei MIYAKE, Kariya-city, Aichi-pref. (JP); Tomoyuki HORI, Kariya-city, Aichi-pref. (JP)

(21) Appl. No.: 15/780,340

(22) PCT Filed: Dec. 2, 2016
(86) PCT No.: PCT/JP2016/085969

§ 371 Date: May 31, 2018

(30) Foreign Application Priority Data
Dec. 4, 2015 (JP) 2015-237545

(51) Int. Cl. B60T 7/12; B60W 10/04; B60W 10/06; B60W 10/18; B60W 30/045; B60W 40/072; B60W 40/101

(52) U.S. Cl. CPC B60T 7/12; B60W 10/04; B60W 10/06; B60W 2550/143; B60W 30/045; B60W 40/072; B60W 40/101; B60W 10/18

(57) ABSTRACT

A traveling control apparatus acquires a shape of a road on which an own vehicle is to travel, and, in the case where the shape of the road changes from a straight road to a curved road, the apparatus calculates an upper limit speed, which prevents the own vehicle from skidding off outside the curved road when the own vehicle travels on the curved road, as a target speed. The traveling control apparatus decelerates the own vehicle from a deceleration start position so that the own vehicle enters the curved road at a constant speed at a time point when the own vehicle enters the curved road. The traveling control apparatus sets the target speed after acceleration has finished when the own vehicle exits the curved road and reaches an acceleration start position, and accelerates the own vehicle from the acceleration start position to an acceleration completion position.

### CROSS REFERENCE TO RELATED APPLICATIONS

This international application is based on and claims the benefit of priority from earlier Japanese Patent Application No. 2015-237545 filed Dec. 4, 2015, the description of which is incorporated herein by reference.

### TECHNICAL FIELD

The present disclosure relates to a technique of controlling vehicle speed of an own vehicle.

### BACKGROUND ART

As a technique of controlling traveling of a vehicle, various techniques are known such as a technique of auxiliary supporting a driving force, braking force, a steering angle, or the like, with respect to driving manipulation of a driver, and a technique of automatically performing all traveling control on behalf of a driver.

In the technique disclosed in PTL 1, a curve starting point on a curved road is detected as a deceleration point at which the speed should be reduced to a target speed. Then, in the technique disclosed in PTL 1, the target speed at the curve starting point on the curved road is set using any one of an allowable lateral acceleration and a road surface friction coefficient, set in advance, and a turning radius of an own vehicle in order that the vehicle safely passes through the curved road.

If the own vehicle continues to decelerate when the own vehicle enters the curved road, because a passenger feels both force of inertia and centrifugal force by deceleration, there is a case where the passenger feels discomfort.

In contrast, according to the technique of PTL 1, because the own vehicle enters the curved road after the own vehicle decelerates to the target speed, it is possible to prevent a passenger from feeling the force of inertia due to deceleration when the own vehicle enters the curved road.

### CITATION LIST

### Patent Literature

[PTL 1] JP 2009-6828 A

### SUMMARY OF THE INVENTION

However, as a result of detailed study by the inventors, a problem has been found that, if acceleration of a vehicle is started before the vehicle exits a curved road in order that acceleration of the vehicle is immediately completed when the vehicle exits the curved road, because a passenger of the vehicle feels both force of inertia and centrifugal force by the acceleration, there is a case where the passenger feels discomfort.

One aspect of the present disclosure provides a technique of suppressing discomfort which is felt by the passenger of the vehicle when the vehicle enters the curved road and when the vehicle exits the curved road.

A traveling control apparatus according to one aspect of the present disclosure includes a shape acquiring unit and a vehicle speed control unit.

The shape acquiring unit acquires a shape of a road on which the own vehicle is to travel. The vehicle speed control unit sets a deceleration start position at which the own vehicle is caused to start deceleration so that the own vehicle enters a curved road at a constant speed at a time when the own vehicle enters the curved road in the case where the shape of the road acquired by the shape acquiring unit changes from a straight road to the curved road, and sets an acceleration start position at which the own vehicle is caused to start acceleration from a time when the own vehicle exits the curved road in the case where the shape of the road acquired by the shape acquiring unit changes from the curved road to the straight road.

According to this configuration, because the own vehicle enters the curved road at constant speed after the vehicle speed is reduced before the own vehicle enters the curved road, a passenger of the own vehicle does not feel the force of inertia caused by deceleration when the own vehicle enters the curved road.

Further, because the own vehicle accelerates after the own vehicle exits the curved road, the passenger of the own vehicle does not feel the force of inertial due to acceleration when the own vehicle exits the curved road, nor the centrifugal force when the own vehicle exits the curved road and accelerates.

Therefore, in one aspect of the present disclosure, when the own vehicle enters the curved road, and when the own vehicle exits the curved road, it is possible to suppress discomfort which is felt by the passenger of the own vehicle.

Note that reference numerals in parentheses recited in the claims indicate correspondence relationship with specific means described in an embodiment which will be described later as one aspect and do not limit the technical scope of the present disclosure.

### BRIEF DESCRIPTION OF THE DRAWINGS

FIG. 1 is a block diagram illustrating a traveling control system according to the present embodiment.

FIG. 2 is a schematic diagram illustrating an own vehicle which travels on a curved road.

FIG. 3 is a flowchart illustrating traveling control processing.

FIG. 4 is a characteristic diagram indicating relationship between curvature and vehicle speed before entering the curved road, during traveling on the curved road and after exiting the curved road.

### DESCRIPTION OF THE EMBODIMENTS

An embodiment to which the present disclosure is applied will be described below on the basis of the drawings.

### 1. CONFIGURATION

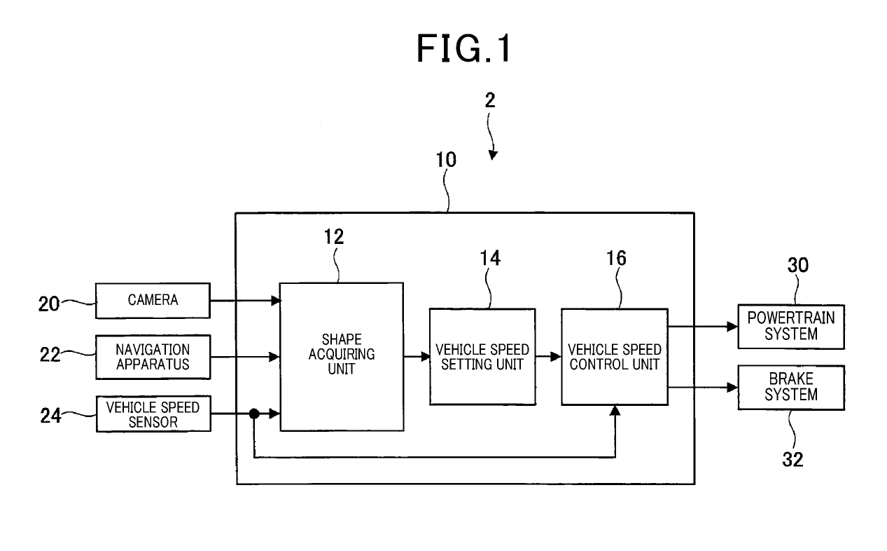

A traveling control system 2 illustrated in FIG. 1 includes a traveling control apparatus 10, a camera 20, a navigation apparatus 22, a vehicle speed sensor 24, a powertrain system 30 and a brake system 32.

The traveling control apparatus 10 in which a computer including a CPU, a RAM, a ROM, a flash memory, an I/O interface, or the like, is mounted, includes a shape acquiring unit 12, a vehicle speed setting unit 14 and a vehicle speed control unit 16. The traveling control apparatus 10 executes a traveling control function corresponding to a program by executing the program recorded in a non-transitory recording medium such as a ROM or a flash memory.

The shape acquiring unit 12 acquires a shape of a road 200 on which the own vehicle 100 travels from image data ahead of the own vehicle 100 captured by the camera 20, map information of a map DB provided at the navigation apparatus 22, or the like.

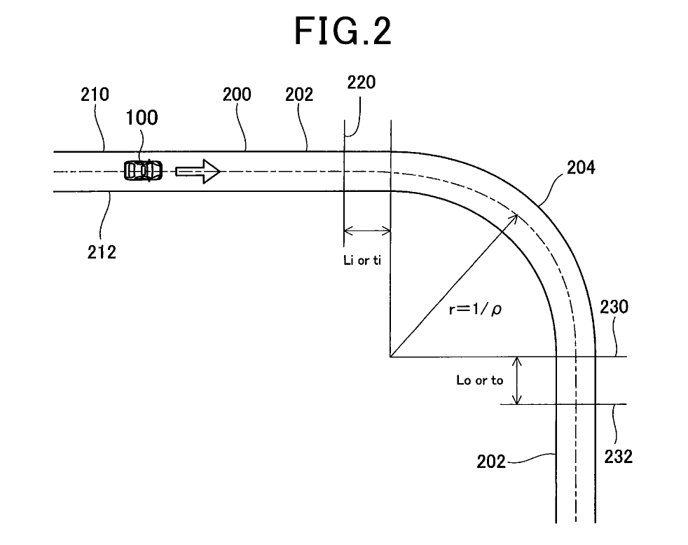

The vehicle speed setting unit 14 sets a target speed of the own vehicle 100 on the basis of the shape of a road ahead of the own vehicle 100, acquired by the shape acquiring unit 12. As illustrated in FIG. 2, the vehicle speed setting unit 14, for example, sets a speed limit specified on a road sign as the target speed in the case where the own vehicle 100 travels on a straight road 202 before the own vehicle 100 enters a curved road 204 and after the own vehicle 100 exits the curved road 204.

In the case where the own vehicle 100X) travels on the curved road 204, the vehicle speed setting unit 14, for example, sets an upper limit speed which prevents the own vehicle 100 from skidding off outside the curved road 204 as the target speed.

The vehicle speed control unit 16 controls the powertrain system 30 and the brake system 32 so that the vehicle speed of the own vehicle 100 becomes the target speed set by the vehicle speed setting unit 14. The camera 20, which is attached, for example, near the center of a mirror of a window shield within a vehicle interior of the own vehicle, captures an image ahead of the own vehicle 100 to output image data.

The navigation apparatus 22 guides a driver through a route to a destination on the basis of a current location of the own vehicle 100 and the destination of the own vehicle 100 input from a touch panel, or the like. The navigation apparatus 22 receives a positioning signal from a positioning satellite such as a GPS satellite and maps a location of the own vehicle on the basis of the map information stored in the map DB. In the map information stored in the map DB, a type of the road, a speed limit of the road, a radius of a curvature of the road, a gradient of the road, or the like, are stored.

The navigation apparatus 22 acquires a speed limit of the road 200 on which the own vehicle 100 is traveling and acquires a radius of a curvature if the road is a curve, from the map information of the map DB and the location of the own vehicle detected by the navigation apparatus 22 receiving the positioning signal from the positioning satellite such as a GPS satellite.

The vehicle speed sensor 24 detects the vehicle speed of the own vehicle 100.

The powertrain system 30 controls opening and a fuel injection amount of a throttle apparatus in the case where an internal combustion is mounted as a drive source in accordance with drive output commanded from the vehicle speed control unit 16, and controls power to be supplied to a motor in the case where the motor is mounted as the drive source.

The brake system 32 controls an actuator provided at a hydraulic circuit of a hydraulic brake in accordance with braking force commanded from the vehicle speed control unit 16. In the case where a motor is mounted on the own vehicle 100 as the drive source, the brake system 32 may control power to be supplied to the motor to generate braking force by a regenerative brake in accordance with the braking force commanded from the vehicle speed control unit 16.

### 2. PROCESSING

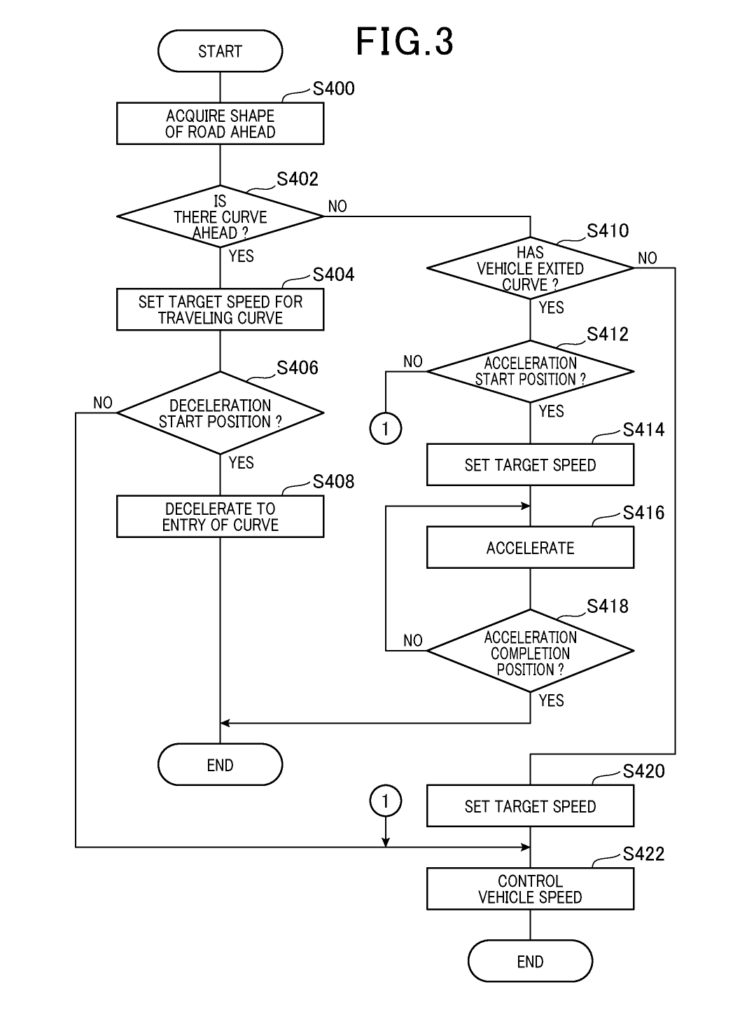

Traveling control processing to be executed by the traveling control apparatus 10 will be described below on the basis of the flowchart in FIG. 3. The flowchart in FIG. 3 is constantly executed at predetermined time intervals.

In S400, the shape acquiring unit 12 acquires a shape of the road 200 ahead on which the own vehicle 100 travels on the basis of at least one of the image data ahead of the own vehicle 100 captured by the camera 20 and the map information stored in the map DB provided at the navigation apparatus 22.

For example, as illustrated in FIG. 2, the shape acquiring unit 12 detects left and right white lines 210 and 212 which specify a traveling road on which the own vehicle 100 travels, for example, on the basis of a luminance difference between the white lines and a road surface on the basis of the image data captured by the camera 20. The shape acquiring unit 12 then calculates a curvature (p) and a radius (r) of the curvature of the road 200 ahead, for example, on the basis of coordinates of the detected left and right white lines 210 and 212.

Further, the shape acquiring unit 12 may acquire a shape of the road 200 ahead from the map information stored in the map DB and the location of the own vehicle detected from the positioning signal of the positioning satellite.

In S402, the vehicle speed control unit 16 determines whether the road ahead is a curved road 204 on the basis of the shape of the road 200 ahead acquired by the shape acquiring unit 12.

In the case where the determination in S402 is No. and the road ahead is not a curved road 204 but a straight road 202, the processing shifts to S410.

In the case where the determination in S402 is Yes, and the road 200 ahead is a curved to road 204, in S404, the vehicle speed setting unit 14 calculates an upper limit speed which prevents the own vehicle 100 from skidding off outside the curved road 204 when the own vehicle 100 travels on the curved road 204. To prevent the own vehicle 100 from skidding, it is necessary that the friction force Ft between a tire and the road surface applied to the own vehicle 100 in a direction opposite to centrifugal force Fv is larger than the centrifugal force Fv applied to the own vehicle 100.

Here, when acceleration of gravity is g, mass of the own vehicle 100 is M, the vehicle speed of the own vehicle 100) is v, a radius of a curvature of the curved road 204 is r, and a friction coefficient between the own vehicle 100 and the road surface on which the own vehicle 100 is to travel is p, the centrifugal force Fv can be expressed with the following equation (1), and the friction force Ft can be expressed with the following equation (2). The friction coefficient μ is set, for example, assuming a case where the own vehicle travels on a wet road surface to minimize occurrence of skidding of the own vehicle 100.

Fv=Mv²/r (1)

Ft=μMg (2)

Further, from relationship of the following equation (3), in a speed range which satisfies the following equation (4), it is possible to prevent the own vehicle 100 from skidding off toward outside of the curved road 204.

Fv=Mv²r<Ft=μMg (3)

v²/r<μg (4)

In S404, the vehicle speed setting unit 14 sets an upper limit obtained by subtracting a detection error of a sensor, or the like, and a deceleration amount set appropriately on the basis of a road surface state and the vehicle speed of the own vehicle 100 from the speed v calculated using the equation (4) as an equality, as an upper limit speed of the own vehicle 100 within a range 10o satisfying the equation (4). The vehicle speed setting unit 14 sets the upper limit speed as a target speed when the own vehicle 100 travels on the curved road 204.

In S406, the vehicle speed control unit 16 determines whether the own vehicle 100 is located at a deceleration start position 220 at which the own vehicle 100 starts deceleration so that the own vehicle 100 enters the curved road 204 at constant speed at a time point when the own vehicle 100 enters the curved road 204.

Whether the own vehicle 100 is located at the deceleration start position 220 is determined in accordance with whether a position where the own vehicle 100 is located is a distance of Li [m] or time of ti [sec] illustrated in FIG. 2 to an entry of the curved road 204. The vehicle speed control unit 16 may set a fixed value as the deceleration start position 220 indicated with Li [m] and ti [sec] or may set the deceleration start position 220 in accordance with a difference between the current vehicle speed and the target speed when the own vehicle 100 travels on the curved road 204.

In the case where, in a state where there is the curved road 204 ahead of the own vehicle 100, the determination in S406 is No, and a position of the own vehicle 100 is not the deceleration start position 220 which is located Li [m] or ti [sec] on this side of the entry of the curved road 204, it is considered that the own vehicle 100 is traveling on the curved road 204.

In this case, the vehicle speed control unit 16 judges that processing of decelerating the own vehicle 100 from the deceleration start position 220 to the entry of the curved road 204 is finished in processing in S408 which will be described later, and the process shifts to S422.

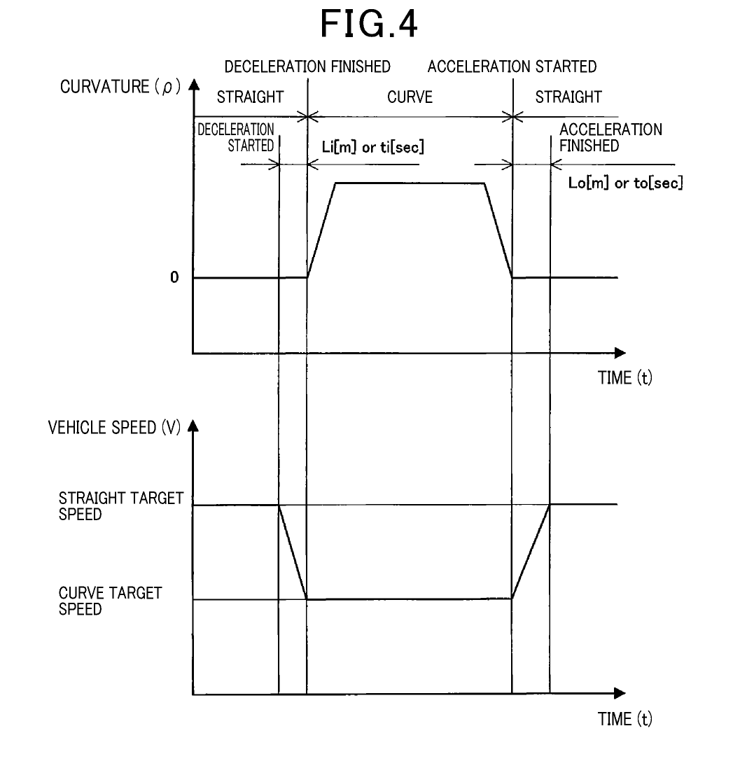

In the case where, in a state where there is the curved road 204 ahead of the own vehicle 100, the determination in S406 is Yes, and the own vehicle 100 is located at the deceleration start position 220, in S408, as illustrated in FIG. 4, the vehicle speed control unit 16 decelerates the own vehicle 100 to the entry of the curved road 204 so that the vehicle speed reaches the target speed set in S404 and becomes constant speed at a time point when the own vehicle 100 enters the curved road 204. The vehicle speed control unit 16 issues a control amount of the driving force and the braking force to the powertrain system 30 and the brake system 32 to reduce the vehicle speed of the own vehicle 100.

In S410, the vehicle speed control unit 16 determines whether the own vehicle 100 is exiting a curved road 204 in a state where the road 200 ahead of the own vehicle 100 is not a curved road 204, but a straight road 202. In the case where the determination in S410 is No, and the own vehicle 100 is not leaving the curved road 204, it is considered that the own vehicle 100 is traveling at a straight portion of the road 200. In this case, the processing shifts to S420.

In the case where the determination in S410 is Yes, and the own vehicle 100 exits the curved road 204, in S412, the vehicle speed control unit 16 determines whether the own vehicle 100 is located at an acceleration start position 230 at which the own vehicle 100 starts acceleration from a time point when the own vehicle 100 exits the curved road 204. In the case where the determination in S412 is No, the processing shifts to S420.

The vehicle speed control unit 16 may set as the acceleration start position 230 a fixed value which corresponding to an exit of the curved road 204 as illustrated in FIG. 2 or may set a predetermined time period or a predetermined distance from when the own vehicle 100 exits the curve 204. Further, the vehicle speed control unit 16 may set a value input by a driver from an input apparatus such as a display as the acceleration start position 230.

In the case where the determination in S412 is Yes, in S414, the vehicle speed setting unit 14 sets a target speed when the own vehicle 100 travels on the straight road 202 after the own vehicle 100 exits the curved road 204 and finishes acceleration. For example, the vehicle speed setting unit 14 sets a speed limit specified on a road sign as the target speed.

In S416, the vehicle speed control unit 16 accelerates the own vehicle 100 until the determination in S418 becomes Yes and the own vehicle 100 reaches an acceleration completion position 232. The vehicle speed control unit 16 issues a control amount of the driving force and the braking force to the powertrain system 30 and the brake system 32 to increase the vehicle speed of the own vehicle 100.

As illustrated in FIG. 2, the acceleration completion position 232 is expressed as Lo [m] as a distance from the acceleration start position 230 until the vehicle speed reaches the target speed set in S414, or to [sec] as a period required for the vehicle speed to reach the target speed from the acceleration start position 230.

The vehicle speed control unit 16 may set a fixed value at the acceleration completion position 232 indicated by Lo [m] or to [sec], or may set the acceleration completion position 232 in accordance with the difference between the target speed when the own vehicle 100 travels on the curved road 204 and the target speed when the own vehicle 100 passes through the curved road 204 and travels on the straight road 202.

Further, because acceleration through accelerator operation requires a longer time period than deceleration through brake operation, Lo [m] may be set longer than Li [m], and to [sec] may be set longer than ti [sec].

In S420, the vehicle speed setting unit 14 sets the target speed when the own vehicle 100 travels on the straight road 202. As described above, the vehicle speed setting unit 14 sets, for example, a speed limit specified on a road sign as the target speed.

In S422, the vehicle speed control unit 16 issues a control amount of the driving force and the braking force to the powertrain system 30 and the brake system 32 so that the actual vehicle speed reaches the target speed, on the basis of the difference between the target speed set in S404 or S420 and the actual vehicle speed detected by the vehicle speed sensor 24.

### 3. EFFECT

In the above-described embodiment described above, the own vehicle 100 decelerates from the deceleration start position 220 so that the own vehicle 100 enters the curved road 204 at constant speed at a time point when the own vehicle 100 enters the curved road 204. Further, the own vehicle 100 accelerates from the acceleration start position 230 at which the own vehicle 100 starts acceleration to the acceleration completion position 232 from a time point when the own vehicle 100 exits the curved road 204. That is, acceleration and deceleration of the own vehicle 100 are not performed while the own vehicle 100 is traveling on the curved road 204.

By this means, because the passenger does not feel the force of inertia due to acceleration and deceleration while the own vehicle 100 is traveling on the curved road 204, it is possible to suppress discomfort to be felt by the passenger due to both centrifugal force and the force of inertia due to acceleration and deceleration while the own vehicle 100 is traveling on the curved road 204.

### 4. OTHER EMBODIMENTS

(1) The friction coefficient to be used for calculating friction force acting in a direction opposite to the centrifugal force may be set as appropriate in accordance with the road surface state. For example, the friction coefficient may be set on the basis of weather information acquired from outside through communication, or the driver may input the friction coefficient in the traveling control apparatus 10 on the basis of weather. Further, the friction coefficient for the case where the friction force acting in a direction opposite to the centrifugal force is calculated, may be set on the basis of a slip ratio calculated from the vehicle speed and rotation speed of a tire.

(2) In the above-described embodiment, functions to be executed by the traveling control apparatus 10 are implemented with software by a program, recorded in a non-transitory recording medium such as a ROM and a flash memory, being executed. In contrast, part or all of the functions to be executed by the traveling control apparatus 10 may be configured with hardware using one or more ICs, or the like.

In the case where part or all of the functions of the traveling control apparatus 10 is configured with electronic circuits which is hardware, the functions can be provided using a digital circuit including a number of logic circuits or an analog circuit.

(3) It is also possible to distribute functions of one component in the above-described embodiment as a plurality of components or integrate functions of a plurality of components in one component. Further, part of the components of the above-described embodiment may be omitted. Still further, at least part of the components of the above-described embodiment may be added to or replaced with the components of the above-described other embodiments. Note that any aspect included in technical idea specified only by words recited in the claims is an embodiment of the present disclosure.

(4) Other than the above-described traveling control apparatus 10, the present disclosure can be realized in various forms such as a traveling control system 2 including the traveling control apparatus 10 as a component, a traveling control program for causing a computer to function as the traveling control apparatus 10, a recording medium in which the traveling control program is recorded, and a traveling control method.

1. A traveling control apparatus comprising:
a shape acquiring unit configured to acquire a shape of a road on which an own vehicle travels; and
a vehicle speed control unit configured to
set a deceleration start position at which the own vehicle starts deceleration on a straight road before a curved road so that the own vehicle enters the curved road at a constant speed at a time point when the own vehicle enters the curved road in the case where the shape of the road acquired by the shape acquiring unit changes from the straight road to the curved road, and
set an acceleration start position at which the own vehicle starts acceleration from a time point when the own vehicle exits the curved road to the straight road and an acceleration completion position at which the own vehicle is caused to finish acceleration on the straight road on which the own vehicle travels after the own vehicle exits the curved road in the case where the shape of the road acquired by the shape acquiring unit changes from the curved road to the straight road.

2. The traveling control apparatus according to claim 1, wherein
the shape acquiring unit acquires the shape of the road from map information or image data ahead of the own vehicle captured by a camera.

3. The traveling control apparatus according to claim 1, wherein
the vehicle speed control unit sets different values at a value of a time period from when the own vehicle enters the curved road from the deceleration start position and a value of a time period to an acceleration completion position at which the own vehicle finishes acceleration from the acceleration start position, or a value of a distance from the deceleration start position to a position at which the own vehicle enters the curved road and a value of a distance from the acceleration start position to the acceleration completion position.

4. The traveling control apparatus according to claim 1, wherein
the vehicle speed control unit sets a time period from when the own vehicle enters the curved road from the deceleration start position and a time period to the acceleration completion position at which the own vehicle finishes acceleration from the acceleration start position, or a distance from the deceleration start position to a position at which the own vehicle enters the curved road and a distance from the acceleration start position to the acceleration completion position on the basis of a speed of the vehicle.

5. The traveling control apparatus according to claim 4, wherein
the vehicle speed control unit sets the time period from the acceleration start position to the acceleration completion position to be longer than the time period from the deceleration start position until the own vehicle enters the curved road, or sets the distance from the acceleration start position to the acceleration completion position to be longer than the distance from the acceleration start position to the position at which the own vehicle enters the curved road.

6. The traveling control apparatus according to claim 1, comprising:
a vehicle speed setting unit configured to set the constant speed so that friction force acting on the own vehicle in a direction opposite to centrifugal force is larger than the centrifugal force acting on the own vehicle when the own vehicle travels on the curved road.
